(19) United States
(12) Patent Application Publication
(10) Pub. No.: US 2002/0146074 A1
(43) Pub. Date: Oct. 10, 2002

(54) Unequal error protection of variable-length data packets based on recursive systematic convolutional coding

(75) Inventors: Meir Ariel, Tel Aviv (IL); Jacob Goldberger, Givatayim (IL); Ofer Amrani, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Cute Ltd.

(21) Appl. No.: 09/785,191

(22) Filed: Feb. 20, 2001

(51) Int. Cl. H04N 7/12

(52) U.S. Cl. 375/240.27; 375/240.16; 375/240.2; 375/240.12

(57) ABSTRACT

A system for streaming data and corresponding protective parity bits in packets over a channel, the system comprising a recursive systematic convolutional encoder at a sending end for producing said corresponding protective parity bits and a recursive systematic convolutional decoder at a receiving end for reconstructing data lost in the channel, and a data interleaver at a sending end for interleaving data for said recursive systematic convolutional encoder according to a uniformity criterion to form parity bits therefrom, and a parity bit distributor operable to distribute said parity bits over said packets differentially from corresponding data. The system is useful in enabling real time multimedia data distribution over cellular networks.

### FIELD OF THE INVENTION

The present invention relates to reliable transmission of data using unequal error protection of variable-length data packets based on recursive systematic convolutional coding and, more particularly but not exclusively, to unequal error protection of variable-length media packets delivered over wireline and wireless networks.

### BACKGROUND OF THE INVENTION

The problem of error concealment in video communications is becoming increasingly important because of the growing interest in the delivery of compressed video over wireless channels. Several packet-oriented transmission modes have been proposed for next generation wireless standards like EGPRS (Enhanced General Packet Radio Service) or UMTS (Universal Mobile Telecommunications System), which are mostly based on the same principle: Long message blocks, typically IP packets that enter the wireless part of the network, are split up into segments of desired length, which can be multiplexed onto link layer packets of fixed size. The packets are then transmitted sequentially over the wireless link, reassembled, and passed on to the next network element. However, compared to the rather benign channel characteristics of present day fixed or wire line networks, wireless links suffer from severe fading, noise, and interference conditions in general, thus resulting in a relatively high residual bit error rate after detection and decoding. By use of efficient cyclic redundancy check (CRC) mechanisms, resulting bit errors are generally detected with very high probability, and every corrupted segment, i.e. a segment which contains at least one erroneous bit, is discarded to prevent error propagation through the network. But if only one single segment is missing at the reassembly stage, the upper layers packet cannot be reconstructed anymore. The result is a significant increase in packet loss rate at higher levels. The effect of such information loss can be devastating since any damage to the compressed bit stream may lead to objectionable visual distortion at the decoder. More importantly, even a small number of erroneous bits can lead to catastrophic error propagation, i.e., to desynchronization of the coded information such that many following bits are undecodable until synchronization is reestablished. Moreover, sometimes the decoded information is still useless even after synchronization is obtained, since there is no way to determine which spatial or temporal locations correspond to the decoded data. It is therefore vitally necessary to keep packet loss within a certain acceptable range depending on the individual quality-of-service (QoS) requirements. However, due to the delay constraints typically imposed by most audio or video codecs, the use of automatic repeat request (ARQ) schemes is often prohibited both at link level and at transport level. In addition, retransmission strategies cannot be applied to any broadcast or multicast scenarios. Thus, forward error correction (FEC) strategies have to be considered, which provide a simple means to reconstruct the content of lost packets at the receiver from the redundancy that has been spread out over a certain number of subsequent packets.

FEC coding is a well-known technique for achieving error correction and detection in data communications. FEC has the disadvantage of increasing transmission overhead and hence reducing usable bandwidth for the payload data. Thus it is generally used judiciously in video services, since video services are very demanding in bandwidth but can tolerate a certain degree of loss.

FEC has been employed for error recovery in video communications in several standards. In H.261, an 18-bit error-correction code is computed and appended to 493 video bits for detection and correction of random bit errors in integrated services digital network (ISDN). For packet video, it is much more difficult to apply error correction because several hundred bits have to be recovered when a packet loss occurs. Lee et al. (S. H. Lee, P. J. Lee, and R. Ansari, “Cell loss detection and recovery in variable rate video,” in Proc. 3rd Int. Workshop Packet Video, Morriston, March 1990, the contents of which are hereby incorporated by reference) propose to combine Reed-Solomon (RS) codes with block interleaving to recover lost ATM cells. An RS (32,28,5) code is applied to every block of 28 bytes of data to form a block of 32 bytes. After applying the RS code row by row in the memory up to the forty-seventh row, the payload of 32 ATM cells is formed by reading column by column from the memory with the attachment of one byte indicating the sequence number. In this way, detected cell loss at the decoder corresponds to one byte erasure in each row of 32 bytes after de-interleaving. Up to four lost cells out of 32 cells can be recovered.

The Grand-Alliance High-Definition Television broadcast system has adopted a similar technique for combating transmission errors (K. Challapali, X. Lebegue, J. S. Lim, W. H. Paik, R. Saint Girons, E. Petajan, V. Sathe, P. A. Snopko, and J. Zdepski, “The grand alliance system for US HDTV,” Proc. IEEE, vol. 83, pp. 158-174, February 1995, the contents of which are hereby incorporated by reference). In addition to using the RS code, data randomization and interleaving are employed to provide further protection. As a fixed amount of video data has to be accumulated to perform the block interleaving described above, relatively long delay is however introduced. To reduce the interleaving delay, a diagonal interleaving method has been proposed by Cochennec (J. -Y. Cochennec, “Method for the correction of cell losses for low bit-rate signals transport with the AAL type 1,” ITU-T SG15 Doc. AVC-538, July 1993, the contents of which are hereby incorporated by reference). At the encoder side, input data are stored horizontally in a designated memory section, which are then read out diagonally to form ATM cells. In the decoder, the data are stored diagonally in the memory and are read out horizontally. In this way, the delay due to interleaving is halved.

The use of FEC for MPEG-2 in a wireless ATM local-area network has been studied by Ayanoglu et al. (E. Ayanoglu, R. Pancha, and A. R. Reibman, and S. Talwar, “Forward error control for MPEG-2 video transport in a wireless ATM LAN,” ACM/Baltzer Mobile Networks Applicat., vol. 1, no. 3, pp. 245-258, December 1996, the contents of which are hereby incorporated by reference). FEC is used at the byte level for random bit error correction and at the ATM cell level for cell-loss recovery. Such use of FEC techniques may be applied to both single-layer and two-layer MPEG data. It is shown that the two-layer coder out performs the one-layer approach significantly, at a fairly small overhead. The paper also compares direct cell-level coding with the cell-level interleaving followed by FEC. It is noted that the paper concludes that the latter introduces longer delay and bigger overhead for equivalent error-recovery performance and suggests that direct cell-level correction is preferred.

Many formats used for transmitting data provide for retransmission in the case of irrecoverable data loss. However, certain data is often required to be used in real time at the receiving end and thus retransmission is unhelpful as the retransmitted data generally arrives too late. A payload format for generic FEC of media encapsulated in Real Time Protocol (RTP) which does not permit retransmission has been proposed by Rosenberg et al (J. Rosenberg and H. Schulzrinne, “An RTP payload format for generic error correction,” RFC 2733, December 1999, the contents of which are hereby incorporated by reference) based on exclusive-or (xor) operation as follows:

The sender takes a set of packets from the media stream, and applies an xor operation across the payloads. The sender also applies the xor operation over components of the RTP headers. Based on the procedures defined in the above-mentioned citation an RTP packet containing FEC information is produced. Such a packet can be used at the receiver to recover any one of the packets used to generate the FEC packet. Use of differing sets results in a tradeoff between overhead, delay, and recoverability. The payload fonnat contains information that allows the sender to tell the receiver exactly which media packets have been used to generate the FEC. Specifically, each FEC packet contains a bitmask, called the offset mask, containing 24 bits. If bit i in the mask is set to 1, it may be concluded that the media packet with sequence number N+i has been used to generate the corresponding FEC packet. N is called the sequence number base, and is incorporated into the FEC packet as well. The offset mask and payload type are sufficient to signal arbitrary parity based FEC schemes with little overhead. As the sender generates FEC packets, they are sent to the receivers. The sender still usually sends the original media stream, as if there were no FEC. Such a procedure allows the media stream to be used by receivers which are not FEC capable.

Some FEC codes, referred to as non-systematic codes, do not require the original media to be sent; as the FEC stream is sufficient for recovery. Such FEC codes have the drawback, however, that all receivers must be FEC capable.

Returning to systematic codes and the FEC packets are not sent in the same RTP stream as the media packets, but rather as a separate stream, or as a secondary codec in the redundant codec payload format. When sent as a separate stream, the FEC packets have their own sequence number space. At the receiver, the FEC and original media are received. If no media packets are lost, the FEC can be ignored. In the event of loss, the FEC packets can be combined with other media and FEC packets that have been received, resulting in recovery of missing media packets. The recovery is exact; the payload is perfectly reconstructed, along with most components of the header. RTP packets which contain data formatted according to such a specification (i.e., FEC packets) are signaled using dynamic RTP payload types.

In greater detail, the xor-based FEC technique presented in RFC2733 uses a function f(x,y, . . . ) defined as the xor operator applied to the packets x,y, . . . The output of this function is another packet, called the parity packet. For simplicity, we assume here that the parity packet is computed as the bitwise xor of the input packets. Recovery of data packets using parity codes is accomplished by generating one or more parity packets over a group of data packets. Four exemplary schemes are given as follows:

Scheme no. 1:

A parity code that generates a single parity packet over two data packets is selected. If the original media packets are a,b,c,d, the packet stream generated by the sender is of the form:

a b c d <- - - media stream

f(a,b) f(c,d) <- - - FEC stream

where time increases to the right. In the present scheme, the error correction code introduces a 50% overhead. If packet b is lost, a and f(a,b) may be used to recover b.

Scheme no. 2

Scheme no. 2 is similar to Scheme no. 1. However, instead of sending packet b followed by the packet formed by f(a,b), f(a,b) is sent before b. Such an order inversion requires additional delay at the sender but has the advantage that it allows certain bursts of two consecutive packet losses to be recovered. The packet stream generated by the sender is of the form:

a b c d e <- - - media stream

f(a,b) f(b,c) f(c,d) f(d,e) <- - - FEC stream

Scheme No. 3

It is not strictly necessary for the original media stream to be transmitted. In scheme no. 3, only non-systematic FEC packets are transmitted. Scheme no. 3 permits recovery of all single packet losses and some consecutive packet losses using slightly less overhead than scheme no. 2. The packet stream generated by the sender is of the form:

f(a,b) f(a,c) f(a,b,c) f(c,d) f(c,e) f(c,d,e) <- - - FEC stream

Scheme no. 4

Scheme no. 4 again sends the original media stream but requires the receiver to wait an additional four packet intervals to recover the original media packets. It can recover from one, two or three consecutive packet losses. The packet stream generated by the sender is of the form:

a b c d <- - - media stream

f(a,b,c) f(a,c,d) f(a,b,d) <- - - FEC stream

In addition to forward error correction, passive error concealment is known. In the case of MPEG video, the objective of passive concealment techniques is to estimate missing macroblocks and motion vectors. The underlying idea is that there is still enough redundancy in the sequence to be exploited by the concealment technique. Passive concealment techniques are used as part of postprocessing methods which utilize spatial data, or temporal data, or a hybrid of both (see, e.g., the papers by M. Wada, “Selective recovery of video packet loss using error concealment,” IEEE J. Select. Areas Commun., vol. 7, pp. 807-814, June 1989, and J. Y. Park, M. H. Lee, and K. J. Lee, “A simple concealment for ATM bursty cell loss,”0 IEEE Trans. Consumer Electron., vol. 39, pp. 704-710, August 1993 the contents of which are hereby incorporated by reference). In such concealment methods, the aim of which is to hide the fact that erazure has taken place, missing macroblocks can be reconstructed by estimating their low-frequency DCT coefficients from the DCT coefficients of the neighboring macroblocks (see, e.g., Y. Wang, Q. Zhu, and L. Shaw, “Maximally smooth image recovery in transform coding,” IEEE Trans. Commun., vol. 41, pp. 1544-1551, October 1993, and Q. Zhu, Y. Wang, and L. Shaw, “Coding and cell loss recovery in DCT based packet video,” IEEE Trans. Circuits Syst. Video Technol., vol. 3, pp. 248-258, June 1993, the contents of which are hereby incorporated by reference), by estimating missing edges in each block from edges in the surrounding blocks as proposed by W. Kwok and H. Sun, “Multidirectional interpolation for spatial error concealment,” IEEE Trans. Consumer Electron., vol. 3, pp. 455-460, August 1993, or by the method of projections onto convex sets as described by H. Sun and W. Kwok in their paper “Concealment of damaged block transform coded images using projections onto convex sets,” IEEE Trans. Image Processing, vol. 4, pp. 470-477, April 1995—the contents of which are hereby incorporated by reference. An alternative to using spatial data for error concealment is to use motion compensated concealment whereby the average of the motion vectors of neighboring macroblocks is used to perform concealment (see M. Wada, “Selective recovery of video packet loss using error concealment,” IEEE J. Select. Areas Commun., vol. 7, pp. 807-814, June 1989—the contents of which are hereby incorporated by reference).

### SUMMARY OF THE INVENTION

According to a first aspect of the present invention there is thus provided an encoding device for encoding a real time data stream for transfer over a noisy channel, the data stream comprising data bits in a succession of data packets, the system comprising:

a data transmitter for sending said data bits in said packets in a utilization order,

a data interleaver for interleaving said data bits into an interleaved order, and

an encoder for encoding said data bits in said interleaved order to form parity bits for insertion into said data stream as a parity set, such that said parity bits are differentially distributed over said packets from said data bits.

Preferably, said data distributor is operable to distribute said data bits into said interleaved order in such a way as to satisfy a uniformity criterion.

Preferably, said uniformity criterion is such as to allow reconstruction of erased data packets from surviving data packets, wherein said erased data packets do not exceed a predetermined proportion of said surviving data packets.

Preferably, said uniformity criterion is such that for any window w taken over said interleaved data, a proportion of interleaved bits originating from any given packet is substantially the same.

Preferably, said data packets comprise a plurality of fields of differing importance and wherein said encoder is operable to apply unequal levels of error protection encoding to said fields.

Preferably, the encoder is operable to apply said unequal levels of error protection encoding via a puncture matrix.

Preferably, said encoder is operable to produce said parity bits using a recursive systematic convolutional encoding process.

Preferably, said recursive systematic convolutional encoding process is defined by

G=(1+D)/(1+D+D²),

Where D indicates a once delayed prior input and D indicates a twice delayed prior input.

Alternatively, said recursive systematic convolutional encoding process is defined by

G=(1+D+D⁴+D⁵+D⁶)/(1+D+D²+D⁴+D⁵),

where D indicates a once delayed prior input, D² indicates a twice delayed prior input, D⁴ indicates a four times delayed prior input, D⁵ indicates a five times delayed prior input, and D⁶ indicates a six times delayed prior input.

Preferably, said data packets are variable size data packets and further comprising a parity bit distributor for distributing said parity bits across said data packets in such a way as to equalize the size of the packets.

Preferably, said encoder is operable to apply said unequal levels of error protection encoding via a puncture matrix.

Preferably, said data packets comprise a plurality of fields of differing importance and wherein said encoder is operable to apply unequal levels of error protection encoding to said fields.

Preferably, the packets being variable size packets, said device further comprises a parity bit distributor for distributing said punctured parity bits across said data packets in such a way as to equalize the sizes of said packets.

Preferably, said data interleaver is operable to interleave said data in accordance with a uniformity criterion and wherein said uniformity criterion is such as to allow reconstruction of erased data packets from surviving data packets, whenever said erased data packets do not exceed a predetermined proportion of said surviving data packets.

Preferably, said uniformity criterion is such that for any window over a length w of said interleaved data, the proportion of data bits from any given packet remains substantially constant.

Preferably, parameters of at least one of said unequal error protection encoding levels and said puncture matrix is included in a packet header.

A preferred embodiment of the present invention is operable to use any selected one of only a predetermined set of combinations of puncture matrices and unequal error protection levels and is operable to include an index of said selected combination in a packet header, thus reducing packet overhead.

An embodiment further comprises a feedback receiver operable to receive feedback from a receiver of said data stream and to modify an encoding scheme based on said feedback.

Preferably, said puncture matrix is selected according to feedback received from a receiver of said data stream. The feedback may typically involve an indication of noise levels in the received signal and the encoder may exchange any of its encoding parameters or may even exchange the encoder itself in response to the feedback.

A preferred embodiment further comprises a parity bit distributor operable to distribute said parity bits in said data stream in an interleaved order in such a way as to satisfy a uniformity criterion.

Preferably, said uniformity criterion is such as to allow reconstruction of erased data packets from surviving data packets, provided that said erased data packets do not exceed a predetermined proportion of said surviving data packets.

Preferably, said uniformity criterion is such that for any window w taken over said interleaved data, a proportion of interleaved parity bits originating from any given packet is substantially the same.

According to a second aspect of the present invention there is provided a decoding device for decoding a real time transmitted data stream received from a noisy channel, the data stream comprising data bits in a utilization order and interleaved parity bits, in a succession of data packets, the system comprising:

a data receiver for receiving said data stream,

a data receiver for deinterleaving said data bits,

a parity bit retriever for retrieving and deinterleaving said parity bits from said data stream, and

a decoder for decoding said data bits with said deinterleaved parity bits, thereby to reconstruct data erased by said channel.

Preferably, said parity bit retriever is operable to retrieve parity bits which have been distributed across said data packets in such a way as to equalize packet sizes.

Preferably, said deinterleaver is operable to deinterleave data bits according to an inverse of a uniformity criterion, said uniformity criterion being such as to allow reconstruction of erased data packets from surviving data packets, whenever said erased data packets do not exceed a predetermined proportion of said surviving data packets.

Preferably, said uniformity criterion is such that for any window over a length w of a data stream over which parity bits from a given data packet are distributed, the proportion of data bits from said given packet is substantially identical.

Preferably, said data packets comprise a plurality of fields of differing importance and wherein said data stream comprises unequal levels of error protection encoding to said fields.

Preferably, said data packets comprise video data compressed using a transform combined with motion vectors of identified macroblocks.

Preferably, said parity bits are defined by the encoding process:

G=(1+D)/(1+D+D²),

Where D indicates a once delayed prior input and D² indicates a twice delayed prior input.

Preferably, said parity bits are defined by the encoding process:

G=(1+D+D⁴+D⁵+D⁶)/(1+D+D²+D⁴+D⁵),

where D indicates a once delayed prior input, D² indicates a twice delayed prior input, D⁴ indicates a four times delayed prior input, D⁵ indicates a five times delayed prior input, and D⁶ indicates a six times delayed prior input.

Preferably, parameters of at least one of said unequal error protection encoding levels and said puncture matrix are obtained from a packet header.

Preferably, said header comprises an index defining a combination of unequal error protection encoding level and a puncture matrix in said packet header.

Preferably, said decoder comprises a trellis decoder operable to determine at least one most likely data path from a plurality of allowed paths using a minimum Hamming distance criterion.

Preferably, said trellis decoder further comprises a progressive windower for use when there remains more than one most likely data path, said progressive windower being operable to progressively window said trellis to enable viewing of sections of said trellis, thereby to exclude ones of said most likely data paths exhibiting predetermined features within said window.

Preferably, said predetermined features include data units not comprised in a predetermined codebook of allowable data units.

Preferably, said predetermined features include data units not comprised in an encoding scheme used to encode the data.

Preferably, said data is visual data and said predetermined features include undesirable visual artifacts.

Preferably, said predetermined features include lack of compatibility with neighboring data units.

Preferably, said predetermined features include improbable distributions of transform coefficients.

Preferably, said transform coefficients are discrete cosine transform coefficients.

A preferred embodiment further comprises a feedback delivery unit for feeding back information indicative of data receipt quality to a data source.

A preferred embodiment preferably comprises a parity bit redistributor operable to recover said parity bits distributed in said data stream in an interleaved order in such a way as to satisfy a uniformity criterion.

Preferably, said uniformity criterion is such as to allow reconstruction of erased data packets from surviving data packets, provided that said erased data packets do not exceed a predetermined proportion of said surviving data packets.

Preferably, said uniformity criterion is such that for any window w taken over said interleaved data, a proportion of interleaved parity bits originating from any given packet is substantially the same.

According to a third aspect of the present invention there is provided a system for streaming data and corresponding protective parity bits in packets over a channel, the system comprising a recursive systematic convolutional encoder at a sending end for producing said corresponding protective parity bits and a recursive systematic convolutional decoder at a receiving end for reconstructing data lost in the channel, and a data interleaver at a sending end for interleaving data for said recursive systematic convolutional encoder according to a uniformity criterion to form parity bits therefrom, and a parity bit distributor operable to distribute said parity bits over said packets differentially from corresponding data.

Preferably, said uniformity criterion is such as to allow reconstruction of erased data packets from surviving data packets, whenever said erased data packets do not exceed a predetermined proportion of said surviving data packets.

Preferably, said uniformity criterion is such that for any window over a length w of a data stream over which parity bits from a given data packet are distributed, the proportion of data bits from said given packet is substantially identical.

Preferably, said data packets comprise a plurality of fields of differing importance and wherein said encoder is operable to apply unequal levels of error protection encoding to said fields.

A preferred embodiment is preferably operable to apply said unequal levels of error protection encoding via a puncture matrix.

Preferably, said recursive systematic convolutional encoder is operable to produce parity bits using a process defined by

G=(1+D)/(1+D+D²),

Where D indicates a once delayed prior input and D² indicates a twice delayed prior input.

Alternatively, said recursive systematic convolutional encoder is operable to produce parity bits using a process deemed by:

G=(1+D+D⁴+D⁵+D⁶)/(1+D+D²+D⁴+D⁵),

where D indicates a once delayed prior input, D² indicates a twice delayed prior input, D⁴ indicates a four times delayed prior input, D⁵ indicates a five times delayed prior input, and D⁶ indicates a six times delayed prior input.

Preferably, parameters of at least one of said unequal error protection encoding levels and said puncture matrix are included in a packet header.

Preferably, said encoder is operable to use any selected one of only a predetermined set of combinations of puncture matrices and unequal error protection encoding levels and which encoder is operable to include an index of said selected combination in a packet header.

A preferred embodiment preferably comprises a feedback path operable to receive feedback from a receiver of said data stream and to modify an encoding level based on said feedback.

Preferably, said puncture matrix is selected according to feedback received from a receiver of said data stream.

Preferably, said decoder comprises a trellis decoder operable to determine at least one most likely data path from a plurality of allowed paths using a minimum Hamming distance criterion.

Preferably, said trellis decoder further comprises a progressive windower operable to view windows over said trellis, such that in a case of more than one most likely path, said trellis may be viewed progressively via said windows thereby to exclude any of said most likely data paths showing predetermined features within a current one of said windows.

Preferably, said predetermined features include data units not comprised in a predetermined codebook of allowable data units.

Preferably, said predetermined features include data units not comprised in an encoding scheme used to encode the data.

Preferably, said data is visual data and said predetermined features include undesirable visual artifacts.

Preferably, said predetermined features include lack of compatibility with neighboring data units. For example, sharp discontinuities which are not continuations of similar discontinuities in neighboring areas could constitute such artifacts.

Preferably, said predetermined features include improbable distributions of transform coefficients.

Preferably, said transform coefficients are discrete cosine transform coefficients.

Preferably, said channel includes a cellular connection.

Preferably, said data comprises compressed video.

Preferably, said compressed video comprises motion vector portions and transformed portions.

Preferably, said packets are variable length packets and said parity bit distributor is operable to distribute parity bits in such a way as to equalize packet lengths.

A preferred embodiment preferably comprises a parity bit distributor operable to distribute said parity bits in said data stream in an interleaved order in such a way as to satisfy a uniformity criterion.

Preferably, said uniformity criterion is such as to allow reconstruction of erased data packets from surviving data packets, provided that said erased data packets do not exceed a predetermined proportion of said surviving data packets.

Preferably, said uniformity criterion is such that for any window w taken over said interleaved data, a proportion of interleaved parity bits originating from any given packet is substantially the same.

According to a fourth aspect of the present invention there is provided a method of transferring compressed multimedia data arranged into fields of varying importance over a channel liable to erasure in variable length packets, the method comprising:

inserting said data into said packets,

interleaving said data using a uniformity criterion,

generating parity bits using a recursive systematic convolutional code from said interleaved data,

distributing said parity bits across said packets amongst said data,

transferring said packets over said channel, and

reconstructing said compressed multimedia data at a receiver.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a generalized diagram of a video packet, showing typical packet fields for the MPEG-4 protocol.

FIG. 2 is a simplified diagram of an RSC encoder for use with embodiments of the present invention,

FIG. 3 is a simplified block diagram which shows a transmission path for a data stream according to an embodiment of the present invention,

FIG. 4 is a simplified block diagram showing the datastream protection encoder of FIG. 3 in greater detail,

FIG. 5 is a simplified block diagram showing the datastream protection decoder of FIG. 3 in greater detail,

FIG. 6 is a trellis diagram showing windowing of the trellis to eliminate data paths, and

FIG. 7 is a simplified block diagram showing a communication system according to a preferred embodiment of the present invention with a feedback channel between the decoder and the encoder.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

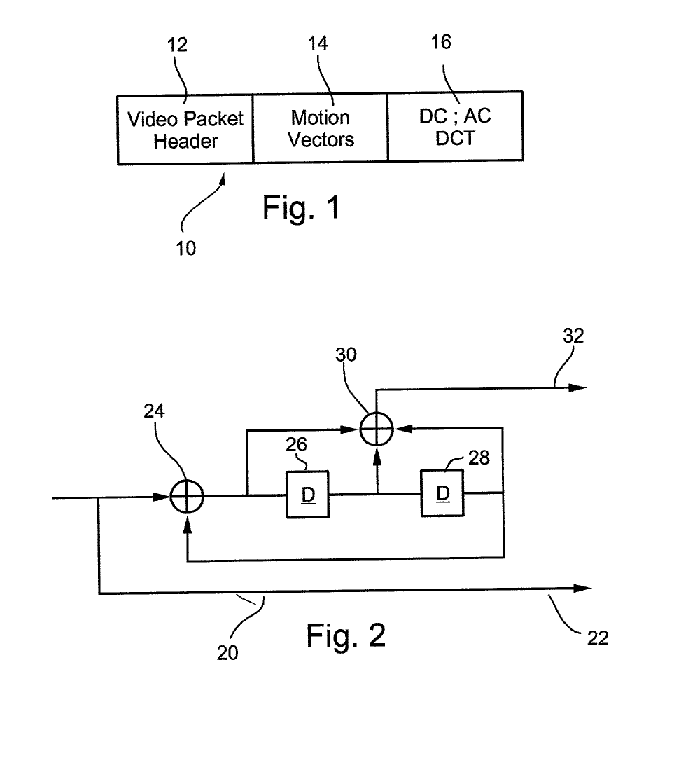

Reference is now made to FIG. 1, which is a simplified diagram showing a standard MPEG-4 data packet for carrying video data over a network. A packet 10 comprises a series of fields as follows: a video packet header 12 which contains general header information relevant to MPEG-4 processing, and two more fields which contain different types of compressed image data, motion vectors 14 and DC and AC DCT data 16.

Generally in MPEG-4, video images are dealt with by dividing a frame into macro-blocks of a given pixel size which are found to persist over a series of images, albeit with slight changes including movement over the image. Thus both an image movement vector and actual image data may be used at different stages to represent the various macro blocks. The image data is generally encoded in three stages, a first stage being discrete cosine transform (DCT), which causes progressively higher levels of detail to migrate towards one corner of the image. A quantization stage then leads to a certain reduction in the quantity of data and this is followed by a stage of Huffman, or variable length, encoding, to provide a high level of data compression. The compressed image data obtained is placed into fields in a series of packets for streaming. Generally in image data, as opposed to text, a certain amount of data loss can be tolerated without the effects being particularly noticeable to the viewer and thus lossy compression methods can be tolerated. However, the compressed data is sensitive to data loss. Reconstruction of the image from the compressed data requires that most of the compressed data be present although reconstruction success is unequally affected by different types of data. In the example of FIG. 1, the video packet header 12 is essential to correct reconstruction of the data, the motion vector data 14 is important but less critical than the header data 12 and the DCT information 14 is least critical of all. Thus, if the packets are being transmitted over a channel in which bandwidth is at a premium, then unequal levels of protection may be provided for the different types of data.

It is therefore desirable to provide packets such as packet 10 of FIG. 1, with a form of protection against channel data loss, distortion and erasure that allows for such unequal levels of protection of parts of the packet. Furthermore, it is desirable to provide a level of protection which allows for reconstruction of the image in the event of erasure of entire packets and even bursts of packets, in the event of their erasure by the channel.

Convolutional coding, and in particular recursive systematic convolutional coding, is a popular error correction scheme in communication systems, largely due to the compact and regular description of the code via a trellis diagram and the corresponding maximum likelihood decoding algorithm known as the Viterbi algorithm (see G. D. Forney, “The Viterbi algorithm,” Proc. IEEE, vol. 61, no. 3, pp. 268-278, March 1973, the contents of which are hereby incorporated by reference). An important advantage of convolutional coding is that it is easy to provide unequal coding levels as discussed above using the same convolution code by means of a technique known as puncturing, which will be described in more detail below.

Furthermore, the use of a systematic code, such as a systematic convolutional code, for error correction is of particular interest as it allows the parity check bits to be transmitted as a separate stream. This has the advantage of rendering the system backwards compatible with non-FEC capable hosts, so that receivers which cannot benefit from the FEC advantages can simply ignore the parity bits. On the other hand, in general, the free distance of systematic convolutional codes is lower than that of the equivalent (same number of states) non-systematic convolutional (NSC) code, consequently giving inferior performance. A recursive systematic convolutional (RSC) code combines the properties of the NSC and systematic codes, and in particular, its bit error rate (BER) performance is better than the equivalent NSC code at any signal to noise ratio for codes rates larger than ⅔.

Reference is now made to FIG. 2, which shows an exemplary systematic recursive convolutional encoder. Encoder 20 is a binary rate ½ NSC encoder with m=2 memory elements, and comprises a first output 22 for direct output of unmodified content data (the systematic output). Content data is additionally fed to a first summator 24 where it is summed with its own output twice delayed by being passed through two delay gates 26 and 28 (the memory elements). A second summator 30 produces a sum of the current, the first delayed and the second delayed outputs of the first summator 24 as a second output 32 (the recursive output).

Generally, a binary rate RSC code is obtained from a NSC code by using a feedback loop and setting one of the two outputs equal to the input bit, for example as in the encoder 20 of FIG. 2. Considering the code generated by the encoder of FIG. 2, the code can be specified by two generator polynomials G′₁=1+D+D², G′₂=1+D², where D represents a delay element. An equivalent RSC code may be represented by the generator polynomials G₁=1, G₂=(1+D+D²)/(1+D²).

As discussed above, unequal levels of encoding may be achieved using such an encoder by puncturing, meaning excluding certain outputs produced by the encoder. Thus for example, all the outputs may be used for the most critical parts of the data, giving maximal reconstructive ability, whereas the least critical parts of the data may use high levels of puncturing to remove most of the parity bits generated by the encoder. Puncturing may be implemented by using a puncture matrix which defines a perforation pattern. For example, for a puncture matrix

$$A = [ \begin{matrix}1 & 1 \\ 1 & 0\end{matrix} ] ,$$

every even parity check bit is punctured, resulting in a rate ⅔ code.

It will be appreciated that if A has zero elements in the first row, then the code ceases to be systematic, since the first row represents the bits of the unmodified data.

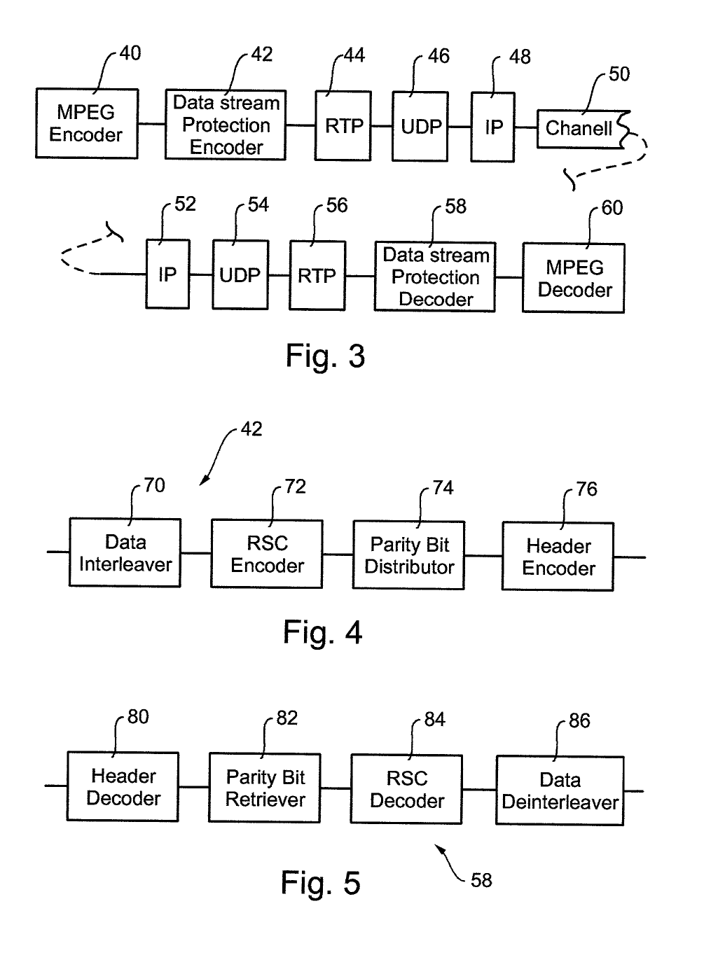

Reference is now made to FIG. 3, which is a simplified block diagram showing a system for managing data packet transfer according to a first embodiment of the present invention. An MPEG encoder 40 produces a stream of packets of the kind shown in FIG. 1, typically variable length packets, which stream is then processed by a datastream protection encoder 42. The data protection encoder 42 performs the function of decreasing the sensitivity of the compressed MPEG-4 data in the received data packets to data loss, distortion or erasure in the channel, as will be explained in greater detail below. The stream is then passed through RTP 44, UDP, 46 and IP 48 protocol layers for transfer along a channel 50. In the channel, the stream is subject to distortion, delay and erasure. It is noted that in the case of multimedia data needed for real time playing, delayed packets are in effect erased packets as they arrive too late.

At the far end of the channel 50, the stream passes through a reversed order of protocol layers, IP 52, UDP 54 and RTP 56, to a datastream protection decoder 58, whose function is complementary to that of the encoder 42 and which will be described in greater detail below. Finally the data packets are passed to an MPEG decoder 60 with channel errors repaired as far as possible.

Considering operation of the system in greater detail, let us take P={p₁, . . . , pₖ} to stand for a set, or stream, of k media packets (bit streams), where each pᵢ is obtained at the output of a media encoder, such as MPEG-4 encoder 40. Thus, each pᵢ is a video packet containing an integer number of compressed macro blocks. The size of a compressed macro block is not fixed, but rather depends on the amount of information it carries and the particular compression algorithm being used by the media encoder 40. Consequently, the length of a video packet is not known in advance and can vary between predefined upper and lower limits. Preferably, l₁, . . . , lₖ denote the lengths of pᵢ, . . . , pₖ, respectively, such that lᵢ is a non-negative integer.

The set P is transmitted over a noisy channel 50. The channel may be a wireline or wireless network or any combination of wireless and wireline, and in particular may at least partially include a cellular network where bandwidth is at a premium. For example, the channel 50 might comprise the RTP/UDP/IP layers of the Internet (as shown), lower layers of the Universal Mobile Telecommunication System (UMTS), and a wireless fading channel in between the physical layers of the UMTS.

Generally, due to the nature of the channel 50, some of the transmitted packets may not arrive in time (or not arrive at all). In addition, some packets may be received partially corrupted, i.e., may contain errors. Denoting by P′ the set of received (and possibly partially corrupted) packets, an objective of the present embodiment is to enable reconstruction of the entire set P from P′. The reconstruction is based on interleaving and RSC encoding applied to the compressed data at the datastream protection encoder 42, as will be described in greater detail below. The RSC encoding, as will be described in greater detail below, preferably generates a set Q of parity check bits. To maintain compatibility with receivers that do not support FEC, the format of the compressed data itself is preferably not affected, i.e., the data is transmitted in a standard compliant (in the preferred embodiment, MPEG-4 compliant) manner (the systematic output of FIG. 2).

Reference is now made to FIG. 4 which is a simplified diagram showing the datastream protection encoder 42 in greater detail. The encoder 42 comprises a data interleaver 70, an RSC encoder 72, a parity bit distributor 74 and a header encoder 76.

The interleaver 70 preferably carries out interleaving only for the purpose of generating the set Q of parity bits. The data, itself is transmitted in a non-interleaved form. In addition, the parity check bits are transmitted separately or in an Internet packet header extension (in the preferred embodiment, RTP header extension). An advantage of the present embodiment is that the selection of any particular RSC code can be changed in real time to enable a judicious tradeoff between complexity and performance. In some of the embodiments the parameters of the selected RSC encoding scheme are preferably appended to the Q set and transmitted to the receiver. In an alternative embodiment the parameters are at least partially set according to reception conditions reported in a feedback path by the receiver, as will be described in greater detail in relation to FIG. 7 below.

Another preferred feature of the present embodiment is its ability, using puncturing as discussed above, to apply unequal error protection (UEP) RSC encoding to different fields of the data according to respective significance levels of the fields. Such a feature is particularly useful in audio/video applications, and enhances the overall performance of the system, as discussed above with respect to FIG. 1. For example, in MPEG-4 encoding the motion vectors are more significant for the reconstruction of the video frame at the receiver than are the DCT coefficients.

The encoding procedure is thus composed of the following four steps:

a) Data interleaving,

b) RSC coding,

c) Interleaving and apportionment of parity bits, and

d) Header encoding

As may be seen from FIG. 4, the data bits are interleaved prior to RSC encoding to prevent, in the event of packet loss, the occurrence of bursts of errors or erasures in the decoding procedure at the receiver. In order to achieve prevention of such bursts, the data interleaving procedure preferably satisfies a uniformity criterion as follows:

Uniformity means that the bits of each packet pi are distributed in a uniform manner along the data interleaved bit stream. More specifically, if W denotes a window of length w through which a portion of the data interleaved stream may be viewed, then for any window W along the interleaved bit stream, pᵢ(W) denotes the number of bits belonging to pᵢ. The uniformity criterion requires that the relative proportion pᵢ(W)/w of bits belonging to each pᵢ is approximately equal to the proportion of lengths lᵢ/s, where

$$s = {\sum }_{i = 1}^{k} {l}_{i}$$

is the total number of data bits.

In a preferred embodiment of the present invention there is provided an algorithm for performing data interleaving according to the aforementioned uniformity criterion. The algorithm selects at each time unit a packet from which the current bit is drawn, and appends the selected bit to the interleaved bit stream. If denoting by nᵢ the number of bits already selected from packet pᵢ, then

$$n = {\sum }_{i = 1}^{k} {n}_{i} ,$$

i.e., n is the total number of bits selected thus far by the algorithm. The packet pᵢ, from which the current bit is drawn, is selected as the packet that minimizes the following expression:

$$\frac{{n}_{i} + 1}{n + 1} - \frac{{l}_{i}}{s} .$$

The algorithm continues as long as n is less than s. If the selected packet is one in which nᵢ is already equal to lᵢ, then a zero bit is inserted instead of a data bit. Note that if all packets have equal lengths, the algorithm is reduced to iteratively passing over all the packets in a circular manner. In the case of unequal originating packets the algorithm adds the greater number of check bits to the smaller packets, giving the advantage that overall reconstructive ability is more evenly distributed around the packets. Thus the loss of any given packet is less likely to have a disproportionately high influence on data reconstruction. Those packets having fewer data bits will have more parity bits and vice versa.

UEP RSC encoding is next preferably applied to the data interleaved bit stream, by the RSC encoder 72. The parameters of the RSC code are:

a feed-forward polynomial,

a feedback polynomial, and

a puncturing pattern.

The puncturing pattern, as discussed above, serves to change the error correction capability of the RSC code according to the priority of the data in the respective field. For example, high-rate error correction coding (i.e., many parity check bits being punctured) may be applied to low-priority data such as high-frequency DCT coefficients, whereas high-priority data such as addresses of blocks, motion vectors, and low-frequency DCT coefficients may be more efficiently protected by applying a sparse puncturing pattern to the RSC coded data. In the following, two examples are given in which rate ½ RSC codes, obtained by computer search, give effective performance with a puncturing pattern

$$A = [ \begin{matrix}1 & 1 \\ 1 & 0\end{matrix} ] .$$

It will, of course, be appreciated that the puncturing changes the rate of the codes to ⅔.

The first exemplary RSC code is a 4-state code with generator polynomials G₁=1 and G₂=(1+D)/(1+D+D²). For k=7 and l₁=l₂= . . . l₇ such a code can recover any combination of 2 out of 7 lost packets. The second exemplary RSC code is a 64-state code with generator polynomials G₁=1 and G₂=(1+D+D⁴+D⁵+D⁶)/(1+D+D²+D⁴+D⁵). For k=10 and l₁=l₂= . . . =l₁₀ the second code can recover any combination of 3 out of 10 lost packets.

The RSC encoding and puncturing procedure, of either example, generates a set Q of parity check bits. The parameters of the RSC encoding scheme are then transmitted to the receiver along with the set Q of parity check bits. As the parameters are explicitly transmitted, any changes therein can be followed at the receiver and thus the parameters may be changed at the encoder in real-time without any prior notification to the receiver.

In UEP encoding, as discussed above, the puncturing pattern is advantageously changed along the interleaved data bit stream according to the importance of the data protected. Thus, the positions along the stream where the puncturing pattern changes are made are preferably transmitted to the receiver.

The RSC encoder 72 is followed by the parity bit distributor 74, whose task is to interleave and apportion the parity bit set Q (after puncturing) before transmission so as to apply the uniformity criterion and thereby to prevent the occurrence of burst errors and erasures at the receiver. The interleaved set Q is preferably apportioned into k portions q₁, . . . , qₖ of lengths m₁, . . . , mₖ, respectively, where each qᵢ is transmitted in the same Internet packet containing pᵢ. The uniformity criterion preferably used in the interleaving and apportionment procedure requires that lᵢ+mᵢ will be approximately the same for all i. As discussed on outline above, in case an Internet packet is lost, the number of missing bits will be approximately constant irrespective of the index of the lost pair {pᵢ, qᵢ}. In order to satisfy such a constraint, a procedure known as a “water filling” procedure may be employed to append parity bits to the data packets.

The uniformity criterion preferably also requires that the missing lᵢ+mᵢ bits are distributed in a uniform manner along the received and de-interleaved bit stream at the input to the UEP RSC decoder (decoder 84 in FIG. 5). Stated otherwise, for any window of length w through which a portion of the de-interleaved bit stream may be viewed, the number of missing bits, in case of one lost packet, will be approximately w/k. The preferred algorithm for interleaving and apportioning Q in parity bit distributor 74 is similar to the algorithm used for interleaving the data bits in data interleaver 70. Preferably, the bits of Q are initially arranged according to the order of their generation by the RSC code in encoder 72. The algorithm then selects, at each time unit, a parity set qᵢ into which a selected next bit of Q is to be placed. Denoting by zᵢ the number of bits already in set qᵢ:

$$z = {\sum }_{i = 1}^{k} {z}_{i} ,$$

that is to say z is the total number of bits distributed thus far by the algorithm. The set qᵢ in which the current bit is placed, is the set that minimizes the following expression

$$\frac{{z}_{i} + 1}{z + 1} - \frac{{m}_{i}}{r} ,$$

where r is the size of Q in bits. Note that this algorithm does not guarantee uniform distribution of parity bits between packets in case one of the data packets is too long, i.e., if one of the lᵢ is greater than (s+r)/k.

The parity bit distributor 74 is followed by the header encoder 76 for performing a final step in the encoding procedure, namely to append a header containing the encoding parameters to the parity bits. The information encoded in the header typically includes:

the lengths {m₁, . . . , mₖ} of the parity bits,

the parameters of the specific RSC code,

the UEP puncturing pattern, and

the tail of the recursive code.

It is appreciated that there is no need to explicitly encode the length of the data packets since this information can be deduced from the remaining parameters. The header is encoded with a fixed predetermined error correction code, and the encoded header bits are then preferably distributed among the transmitted Internet packets. The encoding of the header should be strong enough to allow perfect reconstruction of the header under conditions of severe packet loss.

In an alternative embodiment, in order to reduce the length of the header, a small number of legitimate combinations of header parameters could be determined in advance. In this case, only the index of the selected combination need be transmitted as header information.

Reference is now made to FIG. 5, which a simplified block diagram showing in more detail the datastream protection decoder 58 at the receiving end of the channel 50 in FIG. 3. The datastream protection decoder 58 is designed to receive signals that have been encoded using the datastream protection encoder 42 and preferably comprises similar sub-units thereto but arranged in the reverse order. A header decoder 80 is preferably the first unit in the receiver, followed by a parity bit retriever 82, an RSC decoder 84 and a data deinterleaver 86.

Preferably, decoding is performed on a subset of the transmitted packets as follows. First, encoded header bits are collected from the received packets (i.e., those that have survived transmission through the channel 50). The collected header bits are preferably decoded at the header decoder 80 to recover the header parameters. The recovered header parameters are then used by the parity bit retriever 82 to de-interleave the received set of parity bits and to identify the positions of any erasures that may have occurred. For the purpose of decoding, erasure bits are associated with a zero metric. The header parameters may be used to construct a trellis diagram corresponding to the UEP RSC code that was employed to encode the data. A conventional Viterbi decoding procedure may then be used to decode the received information and reconstruct the interleaved data. The decoding procedure preferably comprises a search through the trellis for the UEP RSC codeword (i.e., bit stream) with minimum Hamming distance form the received sequence of data and parity bits, which, having been found is selected as the most probable bit stream. Then, the selected bit stream is passed to the data deinterleaver 86 for the data to be de-interleaved according to the data de-interleaving scheme (the complement of the data interleaving scheme used by data interleaver 70) and separated into data packets.

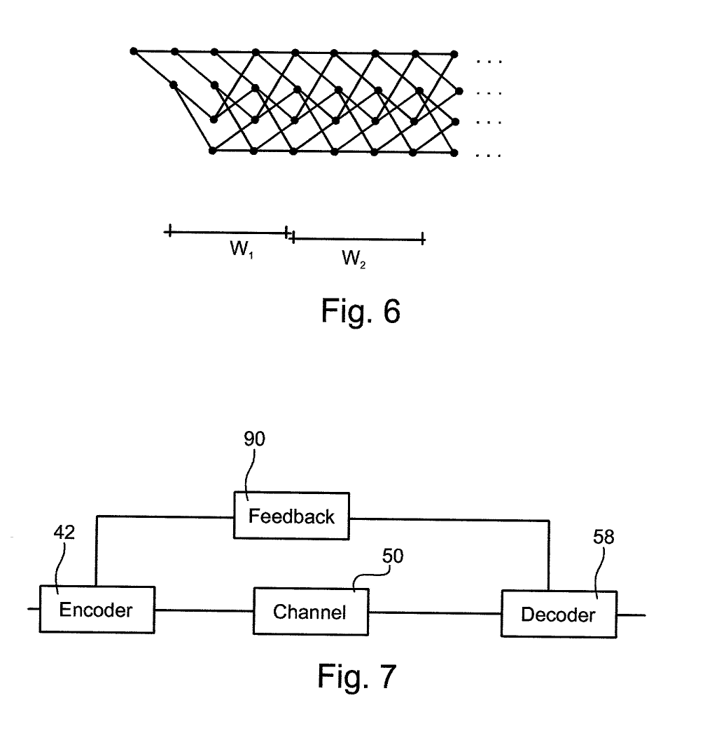

Reference is now made to FIG. 6, which shows eight steps in a simplified trellis diagram. The trellis diagram comprises a series of paths covering all possible message combinations. In normal circumstances, a regular trellis decoding algorithm yields a single surviving path, the path having a minimum Euclidian distance or Hamming weight to the received bit stream. However, if the channel is especially noisy then several paths may be equally probable, and an ability to choose efficiently between paths having equal probability levels extends the ability of the system to deal with channel noise and erasure. Generally, many surviving paths can be rejected because they contain illegal combinations, that is to say combinations of bits that do not appear in a codebook being used. As will be appreciated, in conditions of high channel distortion, the number of surviving paths may grow very large very quickly. Windows, such as those indicated as W1 and W2, are thus used to examine the surviving paths, as will be explained in more detail below.

When the number of lost packets exceeds the error correction capability of the RSC code, the standard Viterbi decoder, even if employed as part of the above-described receiver, will most likely fail to decode to the correct bit stream, that is to say there is a good chance that more than one path will share a minimum Hamming distance, and the standard decoder will be at a loss to choose therebetween. The embodiment of FIG. 6 thus extends the performance of a system that uses trellis coding as a means of FEC of media packets transmitted through a noisy channel. A trellis code is defined as any error correcting code that has a trellis representation, and includes convolutional codes, RSC codes, and even block codes. The present embodiment is useful under conditions of severe packet loss and preferably employs a residual redundancy in the compressed data to be able to select the correct bit stream among a relatively small number of candidate codewords that constitute a sub-trellis of the trellis diagram (in the preferred embodiment the trellis describes an RSC code, although the skilled person will appreciate that the embodiment is applicable to any code having a trellis representation).

In MPEG, particularly MPEG-4, encoding, the multiplexed video bit stream generally comprises variable length code (VLC) words. The video bit stream is not free of redundancy, such that violations of syntactic or semantic constraints will usually occur quickly after a loss of synchronization (see, e.g., C. Chen, “Error detection and concealment with an unsupervised MPEG2 video decoder,” J. Visual Commun. Image Representation, vol. 6, no. 3, pp. 265-278, September 1995, and J. W. Park, J. W. Kim, and S. U. Lee, “DCT coefficients recovery-based error concealment technique and its application to the MPEG-2 bit stream,” IEEE Trans. Circuits Syst. Video Technol., vol. 7, pp. 845-854, December 1997, the contents of which are hereby incorporated by reference). For example, the decoder may not find a matching VLC word in the code table (a syntax violation) or may determine that the decoded motion vectors, DCT coefficients, or quantizer step sizes exceed their permissible range (semantic violations). Additionally, an accumulated run that is used to place DCT coefficients into an 8×8 block may exceed 64, or the number of MB's (macro-blocks) in a group of blocks (GOB) may be too small or too large. Especially for severe errors, the detection of errors can be further supported by localizing visual artifacts that are unlikely to appear in natural video signals.

Another source of reliability information on candidate bit streams useful for eliminating paths within the window may be obtained from receiver provided channel state information, or from a soft output Viterbi algorithm (SOVA) that may be used for decoding of convolutional codes (see J. Hagenauer and P. Hoher, “A Viterbi algorithm with soft-decision output and its applications,” in Proc. IEEE Global Telecommunications Conf. (GLOBECOM), Dallas, Tex., November 1989, pp. 47.1.1-47.1.7, the contents of which are hereby incorporated by reference).

Recently, more advanced techniques for improved resynchronization have been developed in the context of MPEG-4. Among several error resilience tools, data partitioning has been shown to be effective (see R. Talluri, “Error-resilient video coding in the MPEG-4 standard,” IEEE Commun. Mag., vol. 36, pp. 112-119, June 1998—the contents of which are hereby incorporated by reference. In particular data partitioning may be combined with reversible VLC (RVLC), thus allowing bit streams to be decoded in either the forward or reverse direction. In such a case, the number of symbols that have to be discarded can be reduced significantly. Because RVLC's can be matched well to the statistics of image and video data, only a small penalty in coding efficiency is incurred (see, e.g., J. Wen and J. D. Villasenor, “A class of reversible variable length codes for robust image and video coding,” in Proc. 1997 IEEE Int. Conf. Image Processing (ICIP), vol. 2, Santa Barbara, Calif., October 1997, pp. 65-68, and also J. Wen and J. D. Villasenor, “Reversible variable length codes for efficient and robust image and video coding,” in Proc. IEEE Data Compression Conf. (DCC), March 1998, Snowbird, Utah, pp. 471-480, the contents of which are hereby incorporated by reference).

In the present embodiment, a set of data packets (bit stream), which has been encoded by a trellis code at the transmitter is received at the receiver end. The stream is then decoded at the datastream protection decoder 58 using a search through the trellis for the most likely bit stream. If the number of lost packets does not exceed the error correction capability of the trellis code then the conventional Viterbi algorithm may normally be expected to yield a single data path as a most likely candidate for the error-free bit stream. If, however, too many data packets have been lost or corrupted, then the search through the trellis for the most likely bit stream may result in more than one candidate data path, meaning several data paths each having the same likelihood of being the correct bit stream, i.e., being at the same Hamming distance from the received bit stream.

In conventional trellis decoding, if we denote by S the set of the equally likely candidates, then a preferred way to identify the set S is by applying a minimum distance decoder (such as the Viterbi algorithm) to the trellis in the following manner: At each trellis node a comparison is made between the accumulated metrics (accumulated hamming distances) of the paths entering the node. The most likely path to the node is retained and the remaining paths are discarded. If, however, there is a tie, i.e., there are L paths with the same likelihood measure, then all those L paths are retained while the other paths are discarded. This process is repeated for each trellis node and each section until the end of the trellis is reached. At the end of the process, the surviving paths through the trellis constitute a sub-trellis which represents the set S of candidate bit streams.

Generally, the set S of surviving bit streams would be too large to process by the residual redundancy methods described above. Thus in the present embodiment there is provided a low-complexity method to eliminate candidate bit streams and reduce S into a single candidate. A sliding window B of width b is used, and a portion of the sub-trellis may be viewed and processed through the window. In FIG. 6, the window is shown with a width b of three nodes, purely for the purpose of simplicity of illustration. In practice it will generally be larger. The objective is to eliminate paths that are unlikely to be correct. Hence the parameter b should be taken to be large enough to enable meaningful processing of the paths through B, i.e., to enable examination of the elimination criteria described below. At the beginning of the procedure, the window W is positioned at the end of the sub-trellis and the paths through the window W are examined. A path through W is eliminated if it violates a syntactic constraint (e.g., the decoder cannot find a matching VLC word in the code table), a semantic constraint (e.g., the DCT coefficients exceed their permitted range), or some other likelihood criteria as follows:

A decoded bit stream is considered not likely if it includes visual artifacts that are unlikely to appear in natural video images.

A bit stream is not likely if the corresponding DCT coefficient distribution is not likely. Lam et al (Lam, E. Y. and Goodman, J. W., “A mathematical analysis of the DCT coefficient distributions for images” IEEE Trans. Image Processing, Vol. 9, No. 10, October 2000, the contents of which are hereby incorporated by reference) provide a mathematical analysis of the DCT coefficient distributions in natural images. The correspondence between their model and the distribution of the decoded DCT coefficients can be used as a measure of likelihood.

A macroblock is not likely if it has low correlation with its neighboring macroblocks. The correlation can be in the spatial and/or frequency and/or temporal domains. Many appropriate correlation measures have been developed for the purpose of passive error concealment (see Section V in Wang, Y. and Zhu, Q. -F. “, Error control and concealment for video communication: A review” Proc. IEEE Vol. 86, No. 5, May 1998, the contents of which are hereby incorporated by reference). For example, using temporal correlation, a macroblock that is very different from the motion-compensated corresponding macroblock in the previous frame is classified as not likely. Using spatial correlation, a macroblock whose boundaries do not agree with the boundary pixels of neighboring macroblocks in the same frame is classified as not likely.

The processing of the sub-trellis by the sliding window W preferably results in a single survivor path through W. The paths that do not survive the processing by the window W are eliminated from the sub-trellis together with all their “descendents”, i.e., all the paths through the remainder of the sub-trellis that are connected to the eliminated paths. The next step is thus to slide the window b positions towards the beginning of the sub-trellis (window W2 in FIG. 6) and repeat the elimination process. The procedure repeats until the beginning of the sub-trellis is reached. A simple traceback procedure now yields the single surviving bit stream. If at some stage the elimination process cannot be concluded successfully with a single survivor, then a decoding failure is declared. Alternatively, b may be increased to allow a more reliable (and more complex) processing using a larger window.

Reference is now made to FIG. 7, which is a simplified block diagram of a version of the device of FIG. 3 additionally having a feedback loop. Parts that are identical to those shown above are given the same reference numerals and are not referred to again except as necessary for an understanding of the present embodiment. In the embodiment, a datastream protection encoder 42 and a datastream protection decoder are connected via a channel 50 as before, but in addition the channel furnishes a return route which serves as a feedback link 90. The feedback loop allows the decoder 58 to report back to the encoder so that the encoder is able to use real time data from the decoder to set its encoding parameters.

Generally, if a reverse, or feedback, channel from the decoder 58 to the encoder 42 is available, better performance can be achieved since the encoder 42 and decoder 58 are thereby enabled to cooperate in the process of error correction and concealment. The feedback channel 90 may be used to indicate received noise levels and/or which parts of the bit stream were received intact and/or which parts of the video signal could not be decoded and had to be concealed. Depending on the desired error behavior, negative acknowledgment (NACK) or positive acknowledgment (ACK) messages can be sent. Typically, an ACK or NACK may refer to a series of macroblocks or an entire group of blocks (GOB). NACK's require a lower bit rate than ACK's, since they are only sent when errors actually occur, while ACK's have to be sent continuously. In either case, the requirements on the bit rate are very modest compared to the video bit rate of the forward channel.

The feedback message is usually not part of the standard video syntax but transmitted in a layer of the protocol stack which allows for control information to be exchanged. A survey of techniques for processing of acknowledgment information obtained from a feedback channel in general appears in a paper by Girod et al. (B. Girod and N. F. Arber, “Feedback-Based Error Control for Mobile Video Transmission,” Proc. IEEE, Vol. 87, No. 10, October 1999, the contents of which are hereby incorporated by reference.)

In the embodiment of FIG. 7, a system that performs adaptive error correction and concealment in media communications is based on feedback information from the decoder, as described above. Preferably, the embodiment uses the UEP RSC code as described above for error correction of variable-length media packets, where the particular RSC code, the puncturing pattern, the boundaries of the different priority fields, and the data and parity interleaving schemes can be adapted in real time according to control information sent from the decoder 58. Thus, if the decoder indicates that data is being successfully decoded with ease, the level of encoding at the encoder 42 may be reduced. On the other hand, if the decoder 58 indicates that it is having difficulties in decoding, then the level of encoding may be increased and thus there is provided a dynamic response to the conditions of the channel.

The feedback signal may refer to encoding in general. In an embodiment in which unequal encoding is used, the feedback may be specific to the individual data fields.

The embodiment thus preferably offers optimal utilization of bandwidth by allowing real-time adaptivity to channel conditions, real-time controlled unequal error protection, efficient exploitation of the processing power at the transmitter and receiver, and real-time adaptivity to variations in packet size.

In accordance with embodiments of the present invention there is thus provided a system for efficient processing of compressed multimedia data for a real time data stream which makes the compressed data less sensitive to distortions, delays and erasure in the channel.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. An encoding device for encoding a real time data stream for transfer over a noisy channel, the data stream comprising data bits in a succession of data packets, the system comprising:
a data transmitter for sending said data bits in said packets in a utilization order,
a data interleaver for interleaving said data bits into an interleaved order, and
an encoder for encoding said data bits in said interleaved order to form parity bits for insertion into said data stream as a parity set, such that said parity bits are differentially distributed over said packets from said data bits.

2. An encoding device according to claim 1, wherein said data distributor is operable to distribute said data bits into said interleaved order in such a way as to satisfy a uniformity criterion.

3. An encoding device according to claim 2 wherein said uniformity criterion is such as to allow reconstruction of erased data packets from surviving data packets, wherein said erased data packets do not exceed a predetermined proportion of said surviving data packets.

4. An encoding device according to claim 2, wherein said uniformity criterion is such that for any window w taken over said interleaved data, a proportion of interleaved, bits originating from any given packet is substantially the same.

5. An encoding device according to claim 1, wherein said data packets comprise a plurality of fields of differing importance and wherein said encoder is operable to apply unequal levels of error protection encoding to said fields.

6. An encoding device according to claim 5, said encoder being operable to apply said unequal levels of error protection encoding via a puncture matrix.

7. An encoding device according to claim 1, said encoder being operable to produce said parity bits using a recursive systematic convolutional encoding process.

8. An encoding device according to claim 7, wherein said recursive systematic convolutional encoding process is defined by
G=(1+D)/(1+D+D²),
Where D indicates a once delayed prior input and D² indicates a twice delayed prior input.

9. An encoding device according to claim 7, wherein said recursive systematic convolutional encoding process is defined by
G=(1+D+D⁴+D⁵+D⁶)/(1+D+D²+D⁴+D⁵),
where D indicates a once delayed prior input, D² indicates a twice delayed prior input, D⁴ indicates a four times delayed prior input, D⁵ indicates a five times delayed prior input, and D⁶ indicates a six times delayed prior input.

10. An encoding device according to claim 7, wherein said data packets are variable size data packets and further comprising a parity bit distributor for distributing said parity bits across said data packets in such a way as to equalize the size of the packets.

11. An encoding device according to claim 10, wherein said encoder is operable to apply said unequal levels of error protection encoding via a puncture matrix.

12. An encoding device according to claim 11, wherein said data packets comprise a plurality of fields of differing importance and wherein said encoder is operable to apply unequal levels of error protection encoding to said fields.

13. An encoding device according to claim 11, said packets being variable size packets, said device further comprising a parity bit distributor for distributing said punctured parity bits across said data packets in such a way as to equalize the sizes of said packets.

14. An encoding device according to claim 13, wherein said data interleaver is operable to interleave said data in accordance with a uniformity criterion and wherein said uniformity criterion is such as to allow reconstruction of erased data packets from surviving data packets, whenever said erased data packets do not exceed a predetermined proportion of said surviving data packets.

15. An encoding device according to claim 14, wherein said uniformity criterion is such that for any window over a length w of said interleaved data, the proportion of data bits from any given packet remains substantially constant.

16. An encoding device according to claim 13, wherein parameters of at least one of said unequal error protection encoding levels and said puncture matrix is included in a packet header.

17. An encoding device according to claim 13, operable to use any selected one of only a predetermined set of combinations of puncture matrices and unequal error protection levels and which is operable to include an index of said selected combination in a packet header.

18. An encoding device according to claim 1, further comprising a feedback receiver operable to receive feedback from a receiver of said data stream and to modify an encoding scheme based on said feedback.

19. An encoding device according to claim 1, wherein said puncture matrix is selected according to feedback received from a receiver of said data stream.

20. An encoding device according to claim 1, further comprising a parity bit distributor operable to distribute said parity bits in said data stream in an interleaved order in such a way as to satisfy a uniformity criterion.

21. An encoding device according to claim 20 wherein said uniformity criterion is such as to allow reconstruction of erased data packets from surviving data packets, provided that said erased data packets do not exceed a predetermined proportion of said surviving data packets.

22. An encoding device according to claim 20, wherein said uniformity criterion is such that for any window w taken over said interleaved data, a proportion of interleaved parity bits originating from any given packet is substantially the same.

23. A decoding device for decoding a real time transmitted data stream received from a noisy channel, the data stream comprising data bits in a utilization order and interleaved parity bits, in a succession of data packets, the system comprising:
a data receiver for receiving said data stream,
a data receiver for deinterleaving said data bits,
a parity bit retriever for retrieving and deinterleaving said parity bits from said data stream, and
a decoder for decoding said data bits with said deinterleaved parity bits, thereby to reconstruct data erased by said channel.

24. A decoding device according to claim 23, wherein said parity bit retriever is operable to retrieve parity bits which have been distributed across said data packets in such a way as to equalize packet sizes.

25. A decoding device according to claim 24, wherein said deinterleaver is operable to deinterleave data bits according to an inverse of a uniformity criterion, said uniformity criterion being such as to allow reconstruction of erased data packets from surviving data packets, whenever said erased data packets do not exceed a predetermined proportion of said surviving data packets.

26. A decoding device according to claim 25, wherein said uniformity criterion is such that for any window over a length w of a data stream over which parity bits from a given data packet are distributed, the proportion of data bits from said given packet is substantially identical.

27. A decoding device according to claim 23, wherein said data packets comprise a plurality of fields of differing importance and wherein said data stream comprises unequal levels of error protection encoding to said fields.

28. A decoding device according to claim 23, wherein said data packets comprise video data compressed using a transform combined with motion vectors of identified macroblocks.

29. A decoding device according to claim 25, wherein said parity bits are defined by the encoding process:
G=(1+D)/(1+D+D²),
Where D indicates a once delayed prior input and D² indicates a twice delayed prior input.

30. A decoding device according to claim 23, wherein said parity bits are defined by the encoding process:
G=(1+D+D⁴+D⁵+D⁶)/(1+D+D²+D⁴+D⁵),
where D indicates a once delayed prior input, D² indicates a twice delayed prior input, D⁴ indicates a four times delayed prior input, D⁵ indicates a five times delayed prior input, and D⁶ indicates a six times delayed prior input.

31. A decoding device according to claim 27, wherein parameters of at least one of said unequal error protection encoding levels and said puncture matrix are obtained from a packet header.

32. A decoding device according to claim 30, wherein said header comprises an index defining a combination of unequal error protection encoding level and a puncture matrix in said packet header.

33. A decoding device according to claim 23, wherein said decoder comprises a trellis decoder operable to determine at least one most likely data path from a plurality of allowed paths using a minimum Hamming distance criterion.

34. A decoding device according to claim 33, wherein, said trellis decoder further comprises a progressive windower for use when there remains more than one most likely data path, said progressive windower being operable to progressively window said trellis to enable viewing of sections of said trellis, thereby to exclude ones of said most likely data paths exhibiting predetermined features within said window.

35. A decoding device according to claim 34, wherein said predetermined features include data units not comprised in a predetermined codebook of allowable data units.

36. A decoding device according to claim 34, wherein said predetermined features include data units not comprised in an encoding scheme used to encode the data.

37. A decoding device according to claim 34, wherein said data is visual data and said predetermined features include undesirable visual artifacts.

38. A decoding device according to claim 34, wherein said predetermined features include lack of compatibility with neighboring data units.

39. A decoding device according to claim 34, wherein said predetermined features include improbable distributions of transform coefficients.

40. A decoding device according to claim 34, wherein said transform coefficients are discrete cosine transform coefficients.

41. A decoding device according to claim 34, further comprising a feedback delivery unit for feeding back information indicative of data receipt quality to a data source.

42. An decoding device according to claim 24, further comprising a parity bit redistributor operable to recover said parity bits distributed in said data stream in an interleaved order in such a way as to satisfy a uniformity criterion.

43. A decoding device according to claim 42, wherein said uniformity criterion is such as to allow reconstruction of erased data packets from surviving data packets, provided that said erased data packets do not exceed a predetermined proportion of said surviving data packets.

44. An decoding device according to claim 43, wherein said uniformity criterion is such that for any window w taken over said interleaved data, a proportion of interleaved parity bits originating from any given packet is substantially the same.

45. A system for streaming data and corresponding protective parity bits in packets over a channel, the system comprising a recursive systematic convolutional encoder at a sending end for producing said corresponding protective parity bits and a recursive systematic convolutional decoder at a receiving end for reconstructing data lost in the channel, and a data interleaver at a sending end for interleaving data for said recursive systematic convolutional encoder according to a uniformity criterion to form parity bits therefrom, and a parity bit distributor operable to distribute said parity bits over said packets differentially from corresponding data.

46. A system according to claim 45 wherein said uniformity criterion is such as to allow reconstruction of erased data packets from surviving data packets, whenever said erased data packets do not exceed a predetermined proportion of said surviving data packets.

47. A system according to claim 45, wherein said uniformity criterion is such that for any window over a length w of a data stream over which parity bits from a given data packet are distributed, the proportion of data bits from said given packet is substantially identical.

48. A system according to claim 45, wherein said data packets comprise a plurality of fields of differing importance and wherein said encoder is operable to apply unequal levels of error protection encoding to said fields.

49. A system according to claim 48, operable to apply said unequal levels of error protection encoding via a puncture matrix.

50. A system according to claim 45, wherein said recursive systematic convolutional encoder is operable to produce parity bits using a process defined by
G=(1+D)/(1+D+D²),
Where D indicates a once delayed prior input and D² indicates a twice delayed prior input.

51. A system according to claim 45, wherein said recursive systematic convolutional encoder is operable to produce parity bits using a process defined by:
G=(1+D+D⁴+D⁵+D⁶)/(1+D+D²+D⁴+D⁵),
where D indicates a once delayed prior input, D²indicates a twice delayed prior input, D⁴ indicates a four times delayed prior input, D⁵ indicates a five times delayed prior input, and D⁶ indicates a six times delayed prior input.

52. A system according to claim 49, wherein parameters of at least one of said unequal error protection encoding levels and said puncture matrix are included in a packet header.

53. A system according to claim 49, wherein said encoder is operable to use any selected one of only a predetermined set of combinations of puncture matrices and unequal error protection encoding levels and which encoder is operable to include an index of said selected combination in a packet header.

54. A system according to claim 45, further comprising a feedback path operable to receive feedback from a receiver of said data stream and to modify an encoding level based on said feedback.

55. A system according to claim 49, wherein said puncture matrix is selected according to feedback received from a receiver of said data stream.

56. A system according to claim 45, wherein said decoder comprises a trellis decoder operable to determine at least one most likely data path from a plurality of allowed paths using a minimum Hamming distance criterion.

57. A system according to claim 56, wherein said trellis decoder further comprises a progressive windower operable to view windows over said trellis, such that in a case of more than one most likely path, said trellis may be viewed progressively via said windows thereby to exclude any of said most likely data paths showing predetermined features within a current one of said windows.

58. A system according to claim 57, wherein said predetermined features include data units not comprised in a predetermined codebook of allowable data units.

59. A system according to claim 57, wherein said predetermined features include data units not comprised in an encoding scheme used to encode the data.

60. A system according to claim 57, wherein said data is visual data and said predetermined features include undesirable visual artifacts.

61. A system according to claim 57, wherein said predetermined features include lack of compatibility with neighboring data units.

62. A system according to claim 57, wherein said predetermined features include improbable distributions of transform coefficients.

63. A system according to claim 57, wherein said transform coefficients are discrete cosine transform coefficients.

64. A system according to claim 45, wherein said channel includes a cellular connection.

65. A system according to claim 45, wherein said data comprises compressed video.

66. A system according to claim 65, wherein said compressed video comprises motion vector portions and transformed portions.

67. A system according to claim 45, wherein said packets are variable length packets and wherein said parity bit distributor is operable to distribute parity bits in such a way as to equalize packet lengths.

68. A system according to claim 45, further comprising a parity bit distributor operable to distribute said parity bits in said data stream in an interleaved order in such a way as to satisfy a uniformity criterion.

69. A system according to claim 45, wherein said uniformity criterion is such as to allow reconstruction of erased data packets from surviving data packets, provided that said erased data packets do not exceed a predetermined proportion of said surviving data packets.

70. A system according to claim 45, wherein said uniformity criterion is such that for any window w taken over said interleaved data, a proportion of interleaved parity bits originating from any given packet is substantially the same.

71. A method of transferring compressed multimedia data arranged into fields of varying importance over a channel liable to erasure in variable length packets, the method comprising:
inserting said data into said packets,
interleaving said data using a uniformity criterion,
generating parity bits using a recursive systematic convolutional code from said interleaved data,
distributing said parity bits across said packets amongst said data,
transferring said packets over said channel, and
reconstructing said compressed multimedia data at a receiver.
